(19) United States
(12) Patent Application Publication
(10) Pub. No.: US 2009/0113466 A1
(43) Pub. Date: Apr. 30, 2009

(54) System, Method and Computer Program Product for Evaluating Media Streams

(76) Inventor: Einat Amitay, Inbar (IL)

Correspondence Address: IBM CORPORATION, T.J. WATSON RESEARCH CENTER, P.O. BOX 218, YORKTOWN HEIGHTS, NY, 10598, US

(21) Appl. No.: 11/927,724

(22) Filed: Oct. 30, 2007

(51) Int. Cl. H04H 60/33

(52) U.S. Cl. 725/9

(57) ABSTRACT

A method for evaluating a media stream, the method includes: calculating, for each user out of multiple users and in response to media stream commands generated by the user, a user viewing value; wherein the user viewing value represents a relative part of the media stream viewed by the user; and determining an interest value of the media stream in response to user viewing values of each of the multiple users.

### FIELD OF THE INVENTION

The present invention relates to methods, systems and computer program products for evaluating media streams.

### BACKGROUND OF THE INVENTION

The amount of media streams that are to be stored, retrieved, viewed or streamed to users has dramatically increased during the last decade. Multiple indexing solutions are being developed in order to allow efficient retrieval of media streams. Some web sites (such as YouTube™) provide a graphical interface that enables a user to select which media stream (out of multiple candidates) to view. During the selection process (and even during the viewing process of the media stream) the graphical interface displays the number of users that viewed the media stream, the number of users that ranked the media stream and a weighted rank that is based upon ranks (actively) provided by users.

Video processing and, additionally or alternatively, audio processing technologies can be applied in order to index media streams. These methods are costly, resource consuming and do not necessarily reflect user preferences.

There is a growing need to provide efficient methods for evaluating a media stream.

### SUMMARY OF THE PRESENT INVENTION

A method for evaluating a media stream, the method includes: calculating, for each user out of multiple users and in response to media stream commands generated by the user, a user viewing value; wherein the user viewing value represents a relative part of the media stream viewed by the user; and determining an interest value of the media stream in response to user viewing values of each of the multiple users.

Conveniently, the determining comprises defining the media stream as irrelevant if the interest value of the media stream is below a threshold.

Conveniently, the method includes segmenting the media stream in response to the media stream commands.

Conveniently, the calculating is followed by repeating the calculating and the determining for multiple media streams that have at least one similar characteristic and sorting the multiple media streams in response to interest values of the multiple media streams.

Conveniently, the method includes displaying metadata representative of the media stream; wherein the metadata comprises the interest value.

A method for segmenting a media stream, the method includes: receiving information representative of media stream commands and generated by multiple users while viewing the media stream; and segmenting the media stream to media stream segments in response to the received information.

### BRIEF DESCRIPTION OF THE DRAWINGS

The present invention will be understood and appreciated more fully from the following detailed description taken in conjunction with the drawings in which:

FIG. 1 is a flow chart of a method for evaluating a media stream according to an embodiment of the invention;

FIG. 2 is a flow chart of a method for segmenting a media stream according to an embodiment of the invention;

FIG. 3 illustrates a system having media stream evaluation capabilities and its environment, according to an embodiment of the invention; and

FIG. 4 illustrates a sample screen, according to an embodiment of the invention.

### DETAILED DESCRIPTION OF THE DRAWINGS

The present invention provides a method, device and computer program product for evaluating a media stream. A media stream can be a video stream, an audio stream or a combination thereof. For simplicity of explanation the following examples will relate to video streams. Those of skill in the art will appreciate that the systems, method and computer product programs can be applied mutatis mutandis to audio streams. A media stream can be a video clip, a movie or another sequence of information that includes media content.

According to an embodiment of the invention an interest value of a media stream can be deducted from relative parts of the media stream viewed by different users. These relative parts (that can differ from one user to another) can be deduced from media stream commands generated by the different users. If, for example, most users (that started viewing a certain media stream) viewed only a small fraction of the media stream then this media stream can be defined as a non-interesting media stream. It is noted that gathering information relating to larger number of users can provide a more accurate indication.

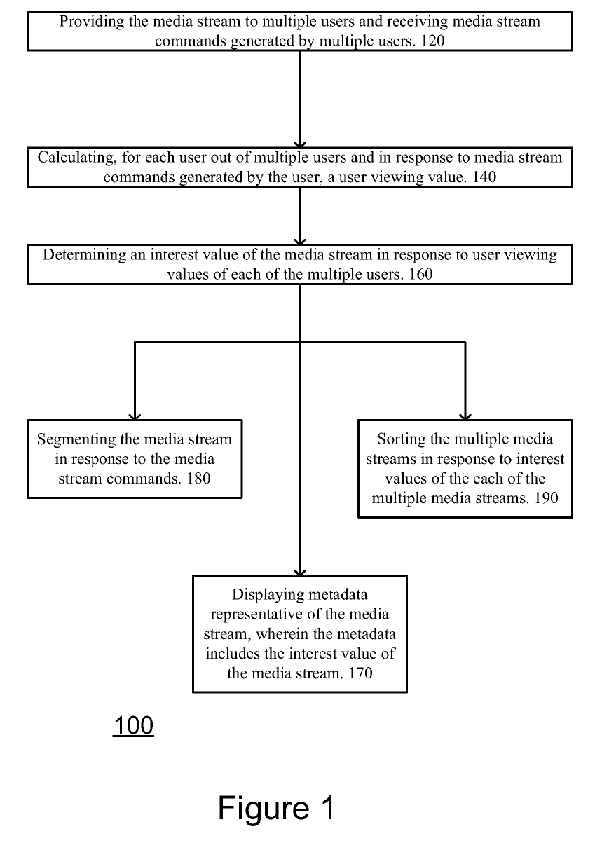

FIG. 1 illustrates method 100 for evaluating a media stream, according to an embodiment of the invention.

Method 100 starts by stage 120 of providing the media stream to multiple users and receiving media stream commands generated by multiple users. Conveniently, the media stream is streamed to the multiple users. It is noted that this is not necessarily so and that users can view the media stream after downloading the media stream to their computerized units. Those of skill in the art will appreciate that associating timing information to media stream commands generated by users can be simplified when the media stream is streamed to the multiple users. It is further noted that if the media streams are viewed in a non-streaming manner (off-line), the method has to check for media stream version consistency or otherwise compensate for timing differences resulting from timing differences between different versions of the media stream.

Method 120 is followed by stage 140 of calculating, for each user out of multiple users and in response to media stream commands generated by the user, a user viewing value. The user viewing value represents a relative part of the media stream viewed by the user. It is noted that stage 120 can include receiving information relating to media stream commands generated by a group of users and that the calculating can be responsive to commands generated by multiple users that form a sub-group of users.

Stage 140 is followed by stage 160 of determining an interest value of the media stream in response to user viewing values of each of the multiple users. The viewing values of different users can be processed in different manners (while applying different algorithms) in order to calculate the interest value. For example, the interest value can be responsive to an average viewing value that is calculated by averaging user viewing values of multiple users.

According to an embodiment of the invention user viewing patterns can be generated and can be taken into account when the interest value is determined. For example, a tendency of certain users to repeatedly review media streams should be taken into account. Yet for another example, a tendency of certain users to view only a fraction of a media stream can also be taken in account. These tendencies are usually evaluated in view of the multiple media stream viewing experiences of these users. Yet for another example, a tendency of certain users to view media stream of certain types (action, drama, comedy, documentary, and the like) can be taken into account.

According to an embodiment of the invention stage 160 includes defining the media stream as irrelevant if the interest value is below a threshold. It is noted that multiple thresholds and interest levels can be defined.

According to an embodiment of the invention stage 160 includes generating a histogram of user viewing values. The histogram can provide an indication about the proportion of users that viewed different relative parts of the media stream.

Conveniently, method 100 further includes stage 180 of segmenting the media stream in response to the media stream commands. The segmentation of the media stream is further explained below, in relation to method 200.

It is noted that stages 120-160 can be used to differentiate between media streams that have one or more similar characteristics (such as the same title). This can assist, for example, to filter out media streams that have misleading titles. Accordingly, multiple repetitions of stage 120-160 (each repetition is performed for a different media stream) can be followed by stage 190 of sorting the multiple media streams in response to interest values of the each of the multiple media streams.

Those of skill in the art will appreciate that the interest value of a media stream can be generated, stored and even displayed to one or more users. This interest value can be displayed instead of or in addition to metadata that indicates the number of users that viewed the media stream, the number of users that (actively) ranked the media stream, a title of the media stream, other cinematographic information and the like.

Accordingly, method 100 can include stage 170 of displaying metadata representative of the media stream, wherein the metadata includes the interest value of the media stream.

According to an embodiment of the invention media stream commands generated by multiple users can assist in segmenting the media stream. The segmentation is responsive to the interest level of different users in different media stream portions. The interest level can be learnt from media stream commands generated by the users in relation to the media stream. Media stream commands can include media stream playing commands and media stream window display commands. The former controls the flow of media stream and can include commands such as PLAY, FAST FORWARD, FAST REWIND, LOW SPEED FORWARD, LOW SPEED REWIND, SKIP, PAUSE, STOP and the like. The latter control the window in which the media stream is displayed and can include window location determining commands, commands that resize the window, commands that cause the window to be partially of fully concealed, commands that cause the window to be displayed in front of one or more windows, and the like. As a rule of thumb, segments of interest are typically those which capture user attention such that are reviewed multiple times, are displayed in large windows that are not concealed by other windows, appear at the center of the screen, and the like.

The timing of these media stream commands as well as the type of the media stream commands is processed in order to segment the media stream. It is noted that acquiring media stream commands of larger numbers of users can provide a more accurate segmentation. The processing can involve performing correlation, applying statistical algorithms and the like. Correlation can be applied in order to compensate between slight timing differences that can be attributed (for example) to user response delays.

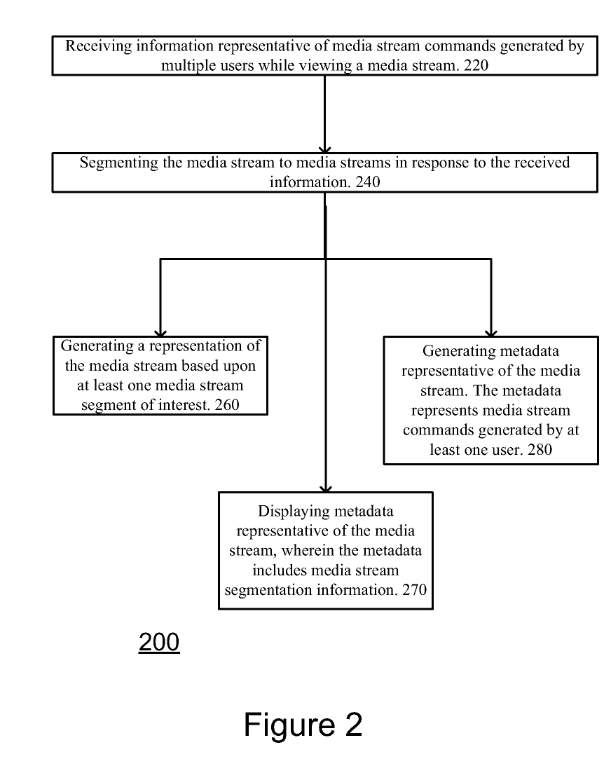

FIG. 2 illustrates method 200 for evaluating a media stream, according to an embodiment of the invention.

Method 200 starts by stage 220 of receiving information representative of media stream commands generated by multiple users while viewing a media stream. The information can include the commands themselves or information that describes the type of command and the timing (usually relative to a certain point in the media stream) of the command.

Stage 220 is followed by stage 240 of segmenting the media stream to media streams in response to the received information.

Conveniently, stage 240 includes calculating interest values of different segments of the media stream, as reflected by the media stream commands generated by multiple users.

Conveniently, the segmenting is responsive to at least one of the following, or to a combination thereof: (i) media stream playing commands, (ii) media stream window display commands; (iii) media stream window display commands that reflect a size of a media stream window in which the media stream is displayed; (iv) media stream window display commands that reflect a relative location within a screen of a media stream window in which the media stream is displayed; (v) media stream window display commands that reflect a relationship between a media stream window in which the media stream is displayed and between at least one other window being displayed on a same screen as the media stream window.

For example, if many users choose to watch the same media stream from a point that is not its beginning, that point may be recorded to reflect the worthiness of a media stream segment that precedes that point as well as the interest value of a media stream segment that follows that point.

According to an embodiment of the invention the start point and, additionally or alternatively, an ending point of a segment can be correlated with a beginning of a scene, an end point of a scene, nearest substantial image change or loudness change point, and the like.

Stage 240 can be followed by at least one stage out of stages 260, 270 and 280.

Stage 260 includes generating a representation of the media stream based upon at least one media stream segment of interest. Thus, stage 260 can include generating a promo and/or a summary of the media stream. A promo or a summary of the media stream usually will include (at least) the most interesting media stream segments, or fractions of these segments.

Those of skill in the art will appreciate that media stream segmentation information can be generated, stored and even displayed to one or more users. The media stream segmentation information can indicate the timing (starting point, end point, length) of one or more segments and even a segment interest value. This information can be displayed in various manners. For example, a status bar can include colored sections that represent interesting segments, and their segment interest values. Accordingly, stage 270 includes displaying metadata representative of the media stream, wherein the metadata includes media stream segmentation information. It is noted that the metadata can be generated by one application and be sent (for example over an API) to another application. Accordingly, various stages of method 200 can be executed by different entities.

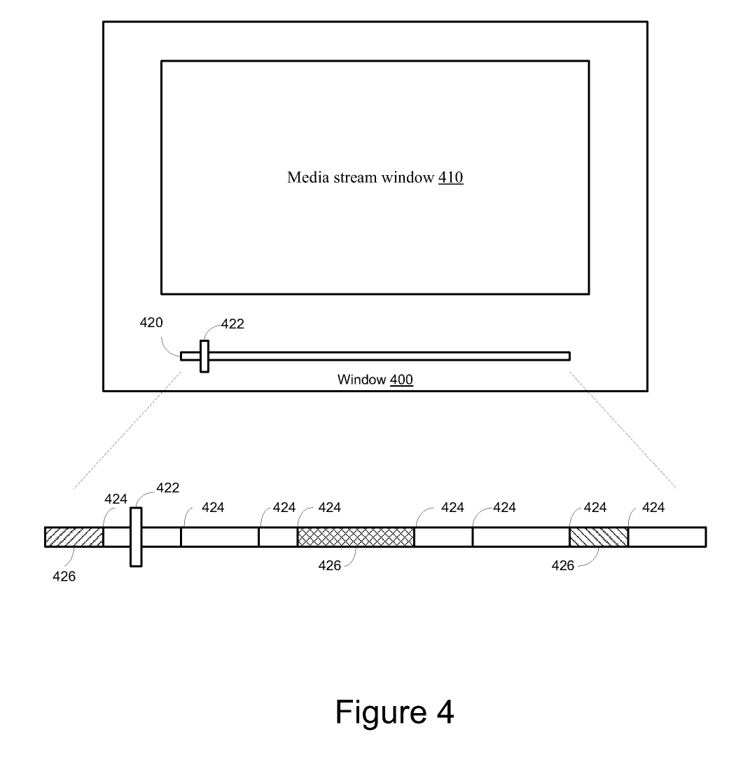

FIG. 4 illustrates window 400, according to an embodiment of the invention. Window 400 includes a media stream window 410 in which the media stream is displayed. A status bar 420 is positioned below window 410. It includes a moving icon 422 that can slide along status bar 420 to indicate the progress of the media stream viewing process. Additional icons 424 can delimit the different segments of the media streams. Different segments can be represented by graphical elements 426. The relevancy value of each segment can be represented by the shape, color and/or texture of its corresponding graphical element.

Conveniently, users can share playlists that indicate how the user viewed the media stream and especially the timing of media stream commands and their type. Referring back to FIG. 2, method 200 can include stage 280 of generating metadata representative of the media stream. The metadata represents media stream commands generated by at least one user. It is noted that users can share playlists if an appropriate API or agreement are provided between applications of different users. The sharing can be implemented using applications such as but not limited to displays.

Conveniently, the segments can be used to index the media stream, especially when contextual information is associated with each segment.

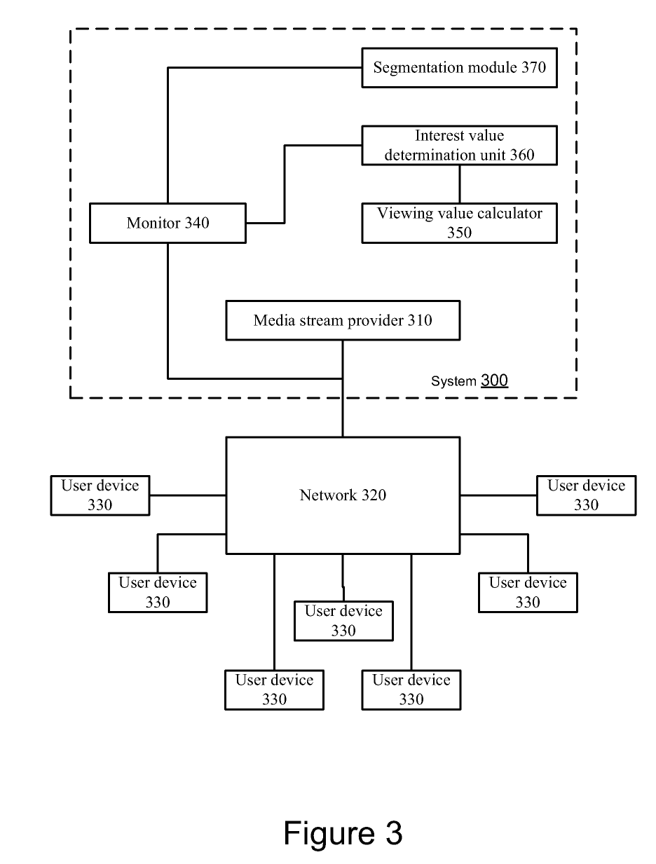

FIG. 3 illustrates system 300 having media stream evaluation capabilities and its environment, according to an embodiment of the invention. For simplicity of explanation it is assumed that the media stream is streamed to multiple user devices by a single computerized entity 310. Those of skill in the art will appreciate that media streams can be provided to multiple user devices in other manners (including non-streaming manners) and by other devices or units, without departing from the scope of the invention.

System 300 is also illustrated as including media stream segmentation capabilities. Those of skill in the art will appreciate that systems that can have only one of these functionalities (segmentations and evaluation) can be provided without departing from the spirit of the invention.

System 300 includes media stream provider 310, monitor 340, user viewing value calculator 350, interest value determination unit 360 and segmentation module 370. System 300 can have a distributed or a centralized configuration and these mentioned modules can be spaced apart from each, located in close proximity to each other, integrated with each other and the like.

Media stream provider 310 that can stream a media stream over network 320 to multiple user devices 330, such as to enable users to view the media stream. A user device can be a computer, a mobile phone, a media player, a personal digital assistant (PDA) and the like. Each user device can include a screen on which the media stream can be displayed. Media stream provider 310 can be a media streaming server, a mesh of multiple media streaming servers, a video on demand server, and the like.

Monitor 340 monitors media stream commands generated by the users that watch the media stream. It is noted that monitor modules (not shown) can be installed in user devices and these monitor modules can monitor media stream commands including media stream window display commands.

User viewing value calculator 350 is adapted to calculate, for each user out of multiple users and in response to media stream commands generated by the user, a user viewing value. The user viewing value represents a relative part of the media stream viewed by the user. An interest value determination unit 360 determines an interest value of the media stream in response to user viewing values of each of the multiple users.

Segmentation module 370 segments the media stream to media stream segments in response to the received information.

It is noted that system 300 can include or be connected to one or more storage systems that can store information that is generated during the media stream evaluation and/or segmentation process.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Conveniently, a computer program product is provided. The computer program product includes a computer usable medium that includes a computer readable program, wherein the computer readable program when executed on a computer causes the computer to receive information representative of media stream commands generated by multiple users while viewing a media stream; and segment the media stream to media stream segments in response to the received information.

Conveniently, a computer program product is provided. The computer program product includes a computer usable medium that includes a computer readable program, wherein the computer readable program when executed on a computer causes the computer to calculate, for each user out of multiple users and in response to media stream commands generated by the user, a user viewing value; wherein the user viewing value represents a relative part of the media stream viewed by the user; and determine an interest value of the media stream in response to user viewing values of each of the multiple users.

The computer readable program can cause the computer to execute one or more states of any method out of methods 100 and 200.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the following claims.

We claim:

1. A method for evaluating a media stream, the method comprising:
calculating, for each user out of multiple users and in response to media stream commands generated by the user, a user viewing value; wherein the user viewing value represents a relative part of the media stream viewed by the user; and
determining an interest value of the media stream in response to user viewing values of each of the multiple users.

2. The method according to claim 1 wherein the determining comprises defining the media stream as irrelevant if the interest value of the media stream is below a threshold.

3. The method according to claim 1 further comprising segmenting the media stream in response to the media stream commands.

4. The method according to claim 1 wherein the calculating is followed by repeating the calculating and the determining for multiple media streams that have at least one similar characteristic and sorting the multiple media streams in response to interest values of the multiple media streams.

5. The method according to claim 1 further comprising displaying metadata representative of the media stream; wherein the metadata comprises the interest value.

6. A method for segmenting a media stream, the method comprises:
receiving information representative of media stream commands and generated by multiple users while viewing the media stream; and
segmenting the media stream to media stream segments in response to the received information.

7. The method according to claim 6 wherein the segmenting comprises calculating interest values of different segments of the media stream, as reflected by media stream commands generated by multiple users.

8. The method according to claim 6 wherein the segmenting is responsive to media stream commands that comprise media stream playing commands and media stream window display commands.

9. The method according to claim 6 wherein the segmenting is responsive to media stream window display commands that reflect a size of a media stream window in which the media stream is displayed.

10. The method according to claim 7 further comprising generating metadata representative of the media stream; wherein the metadata represents media stream commands generated by at least one user.

11. A computer program product comprising a computer usable medium that stores a computer readable program, wherein the computer readable program when executed on a computer causes the computer to:
calculate, for each user out of multiple users and in response to media stream commands generated by the user, a user viewing value; wherein the user viewing value represents a relative part of the media stream viewed by the user; and
determine an interest value of the media stream in response to user viewing values of each of the multiple users.

12. The computer program product according to claim 11 that causes the computer to segment the media stream in response to the media stream commands.

13. The computer program product according to claim 11 that causes the computer to repeat a calculation of user viewing values and a determination of interest value of a media stream for multiple media streams that have at least one similar characteristic and sorting the multiple media streams in response to interest values of the multiple media streams.

14. The computer program product according to claim 11 that causes the computer to participate in a display of metadata representative of the media stream; wherein the metadata comprises the interest value.

15. A computer program product comprising a computer usable medium that stores a computer readable program, wherein the computer readable program when executed on a computer causes the computer to:
receive information representative of media stream commands generated by multiple users while viewing a media stream; and
segment the media stream to media stream segments in response to the received information.

16. The computer program product according to claim 16 that causes the computer to calculate interest values of different segments of the media stream, as reflected by media stream commands generated by multiple users.

17. The computer program product according to claim 16 that causes the computer to segment in response to media stream commands that comprise media stream playing commands and media stream window display commands.

18. The computer program product according to claim 16 that causes the computer to segment in response to media stream window display commands that reflect a relationship between a media stream window in which the media stream is displayed and between at least one other window being displayed on a same screen as the media stream window.

19. The computer program product according to claim 16 that causes the computer to generate a representation of the media stream based upon at least one media stream segment of interest.

20. The method according to claim 16 further comprising generating metadata representative of the media stream; wherein the metadata represents media stream commands generated by at least one user.

21. A system for evaluating a media stream, the system comprises:
a user viewing value calculator adapted to calculate, for each user out of multiple users and in response to media stream commands generated by the user, a user viewing value; wherein the user viewing value represents a relative part of the media stream viewed by the user; and
an interest value determination unit adapted to determine an interest value of the media stream in response to user viewing values of each of the multiple users.

22. The system according to claim 21 wherein the interest value determination unit defines the media stream as irrelevant if the interest value of the media stream is below a threshold.

23. The system according to claim 21 further comprising a segmentation module that is adapted to segment the media stream in response to the media stream commands.

24. The system according to claim 21 adapted to repeat a calculation of user viewing values and a determination of interest value of a media stream for multiple media streams that have at least one similar characteristic and sorting the multiple media streams in response to interest values of the multiple media streams.

25. The system according to claim 21 further adapted to display metadata representative of the media stream; wherein the metadata comprises the interest value.
